(19) United States
(12) Patent Application Publication
(10) Pub. No.: US 2003/0164808 A1
(43) Pub. Date: Sep. 4, 2003

(54) Display system for producing a virtual image

(76) Inventors: John G. Amery, Elsberry, MO (US); Michael E. Stockton, Bland, MO (US)

Correspondence Address: Michael S. Smith, BLACK LOWE & GRAHAM PLLC, 816 Second Avenue, Seattle, WA, 98104, US

(21) Appl. No.: 10/091,156

(22) Filed: Mar. 4, 2002

(51) Int. Cl. G09G 5/00

(52) U.S. Cl. 345/32

(57) ABSTRACT

The present invention is visual display system and method for producing a display image perceived as a far-focused virtual image by an operator. The display system includes a video image generation and display system, and a lens. The video image generation and display system includes an image generator and a video display electrically connected to the image generator. The image generator generates a video signal. The video display displays a video image based on the generated video signal. The lens is positioned between the operator and the video display. The lens allows the operator to perceive the displayed image as a far-focused virtual image.

### FIELD OF THE INVENTION

This invention relates generally to visual display systems and methods and, more particularly, to a system for displaying virtual images.

### BACKGROUND OF THE INVENTION

Visual display systems are commonly used to simulate training environments where training through actual operations would be dangerous, expensive, or otherwise impractical. One common application for visual display systems is flight simulation and training systems. A typical flight simulation and training system requires visual “out the window” images simulating the terrain, landscape, cultural features, buildings, vehicles, and other aircraft in the simulated vicinity of the trainee.

One form of conventional flight simulator includes the projection of images onto the inside of a large, spherically-shaped dome or partial dome structure. The images are displayed inside the domes using multiple video projectors and associated optical devices mounted inside the domes. These projectors and optics must be carefully positioned inside the domes in order to properly display the simulated images.

Another conventional form of a flight simulator typically includes one or more video display screens onto which video images are projected by one or more projectors, such as cathode ray tubes. The video images may be projected onto the display screens from either the front or the rear of the screens. An example of such a conventional flight simulator is the Visual Integrated Display System (VIDS), manufactured by The Boeing Company, the assignee of the current invention. The VIDS provides four rear-projected video screens positioned a few feet from the trainee for displaying simulated images in front of the trainee and up to three additional rear-projected display screens for displaying simulated images behind the trainee.

Conventional simulators also usually include a control panel, a control stick, and a throttle for providing input to the visual display system in response to the displayed video images. The control panel and surrounding environment are often realistic simulations of the controls and displays present in the actual craft. Thus, the operator can simulate the movement of a vehicle and can respond to the environment as depicted by the visual display.

One primary objective of simulators is to enhance and optimize the simulated images to present the operator with a high fidelity and realistic visual environment. Problems experienced by conventional simulators include diminished brightness and contrast, and a low resolution of projected images. These problems arise in large part because of the capability of conventional video projectors, and the use of a relatively small number of video screens (necessitating that each video projector project a relatively large image). Additionally, conventional simulators generally provide a real image that is focused relatively close to the trainee's eyes, not at a far distance, thereby causing visual fatigue. Another drawback to conventional flight simulators is the size of the projectors, display screens, and associated electronics and optics. An improved simulator would have a reduced overall size, allowing the entire simulator to be located in a small room, thus reducing the cost of installing and operating the flight simulator.

U.S. Pat. No. 6,152,739 (the '739 patent) issued to Amery et al. and assigned to the Boeing Company introduces a virtual mosaic display system that produces high quality virtual images using a plurality of displays with a corresponding plurality of Fresnel lenses. The '739 patent shows a pattern of adjacently located lenses and is hereby incorporated by reference. The cost of components and construction of the virtual mosaic display is reasonable for a corporate or military simulator application, but may be excessive as a personal virtual image system.

Video/entertainment games are low cost systems. However, the games produce real images that don't give one the feel of flying in an actual environment.

Therefore, there exists a need to produce a low cost, virtual image system.

### SUMMARY OF THE INVENTION

The present invention is a visual display system and method for producing a display image perceived as a far-focused virtual image by an operator. The display system includes a video image generation and display system, and a lens. The video image generation and display system includes an image generator and a video display electrically connected to the image generator. The image generator generates a video signal. The video display displays the generated video image based on the generated video signal. The lens is positioned between the operator and the video display.

In accordance with further aspects of the invention, the lens has an associated focal length designed such that the display image viewed through the lenses appears at a desired distance.

In accordance with other aspects of the invention, the lens is oriented parallel to the video display and substantially perpendicular to a line extending from the operator's view point.

In accordance with still further aspects of the invention, the lens allows the operator to perceive the displayed image as a far-focused virtual image. The positive lens is a Fresnel type lens.

In accordance with yet other aspects of the invention, the video display includes a flat-panel display.

### BRIEF DESCRIPTION OF THE DRAWINGS

The preferred and alternative embodiments of the present invention are described in detail below with reference to the following drawings.

FIG. 1 is a block diagram showing components of one embodiment of the present invention;

FIG. 2 is a perspective diagram of the present invention; and

FIG. 3 is a top or side view of the present invention.

### DETAILED DESCRIPTION OF THE INVENTION

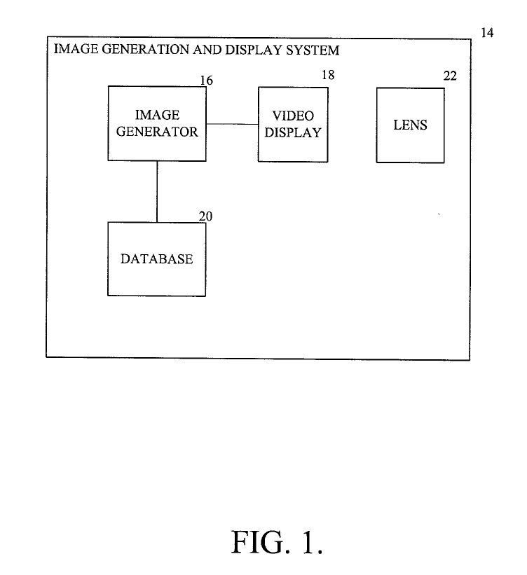

FIG. 1 illustrates components of an image generation and display system 14 according to the present invention. The system 14 includes an image generator 16 electrically coupled to a video display 18 and a database 20. The video display 18 may be, for example, a low cost flat panel display, such as a conventional liquid crystal display (LCD) having a back fluorescent light source as commonly employed in laptop notebooks or other portable computers. Examples of other type of flat panel displays are field emission displays, plasma displays, and flat panel CRTs. The system 14 also includes a lens 22.

The image generator 16 generates a video signal based on an image application program (e.g., flight simulator, video game, etc.) stored on a hard disk or other non-volatile memory internal or external of the system 14 and executed by the image generator 16. The image generator 16 is suitably a conventional desktop personal computer or any other similar commercially available computing apparatus capable of generating video images. It will be appreciated that the image generation and display system 14 can include other components that are not shown, such as a power supply, interface cards, video accelerator cards, hard disks, and other conventional components. Because the aforementioned components are well known in the art, it will be appreciated that a detailed description of their construction and operation is not necessary for an understanding of the present invention.

The database 20 includes a predefined three-dimensional structural database that is used by each of the image generators 16 to create the image that will be displayed on the video display 18 based on user interface inputs. The video display 18 is associated with a lens 22. The lens 22 is suitably an optical element that produces a substantially distortion-free, collimated, virtual image. Example optical elements include a Fresnel lens, a holographic optical element (HOE), a diffraction pattern, any other type of optical element, or a combination of any of the above. An example of a positive lens is a Fresnel-type lens having a planar surface. As is commonly known, a Fresnel lens is a thin replica of a Plano lens cut into rings to obtain a flat profile. Each optical lens 22 is preferably mounted to a structural system (not shown) that also holds the display systems 14 and may hold the image generation components. The optical lens 22 is preferably mounted parallel to the surface of the video display 18 with its optical axis pointed toward a viewer's line of sight.

The focal length of the lens 22 is preferably optimized for the particular size of the simulator and the size of the video displays 18, and to accommodate the operator's anticipated head movement. Further, the focal length of the lens 22 is selected based on two distances: the distance from the pilot's viewing position to the lens 22 and the distance from the lens 22 to the video display 18. These two distances are then adjusted for apparent virtual image location based on desired view distance and field of view available to the viewer. Thus, the focal length of the lens 22 is designed such that the portion of the image viewed through the lens 22 is perceived to be at a predetermined distance.

Preferably, the Fresnel lens has a profiled surface structure in the form of grooves extending with a circular symmetry relative to the optical axis of the lens 22, i.e., perpendicular to the surface of the lens 22. The preferred Fresnel type of lens used in the present invention may be formed on a suitable transparent material such as acrylic or glass, in accordance with well known pressing and cutting operations. The lens 22 may be manufactured as one large lens and then machined into the proper size and shape. Reflexite® Display Optics produces positive lenses that are suitably used in the present invention.

In another embodiment, the lens 22 is a Fresnel lens with color separation correction, i.e. an achromatic Fresnel lens. In one example, a circular diffraction pattern is added to the Fresnel lens opposite the traditional grooves. In another example, an HOE is added to the Fresnel lens. The HOE emulates the circular diffraction pattern.

The image displayed on the video display 18 is viewed by the viewer through the optical lens 22. The video display 18 is arranged and positioned at a distance from the predetermined viewing position of the viewer such that a virtual image created. The virtual image is created by placing the optical element (lens 22) at a distance from the display 18 equal to or less than the element's focal length. Thus, the image seen by the viewer through the lens 22 requires the viewer's eyes to slightly converge (or be parallel), allowing the viewer to perceive a far-focused or substantially collimated virtual image—not a close real image. Thus, the image is perceived to be at a greater distance from the viewer than the distance between the viewer and the video display 18. When a virtual image is created at 20 feet or more from a human with typical eye separation, the eyes are widely converged at a far image and the eyes are focused at a far image. Thus, for a simulated distant virtual image no conflicting information is sent to the mind to confuse it.

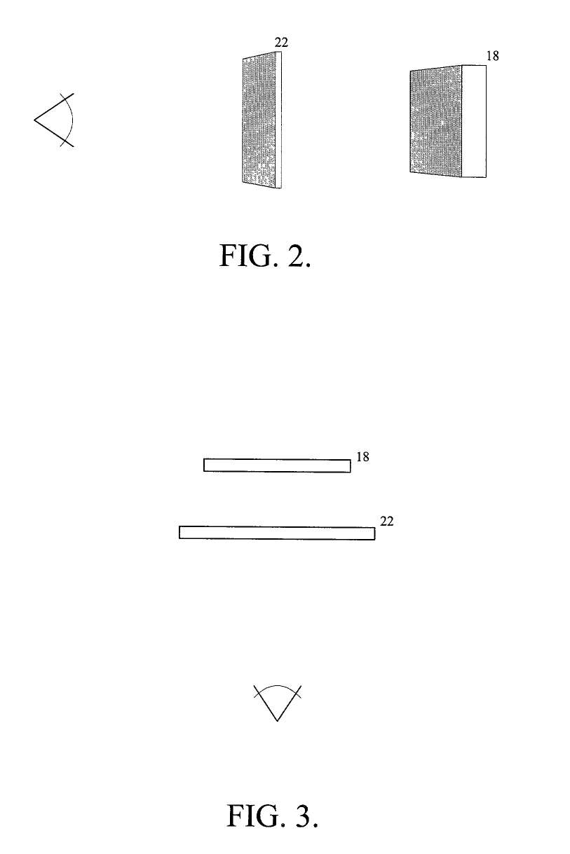

The optical lens 22 is preferably rectangular in shape or the shape of the real image (display 18). FIG. 2 shows a perspective view of the system 14 and FIG. 3 shows a side or top view of the system 14. The lens 22 is preferably arranged such that its surface is substantially perpendicular to the viewer's line of sight. The present invention involves a viewer that has some freedom of movement or head box movement. To allow for a sufficient head box size, the present invention allows the viewer to view only a part of the total image on the display 18. When the head is moved side to side or up and down, the viewer sees other parts of the real image.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A visual display system for producing a display image perceived as a far-focused virtual image by an operator, the display system comprising:
a video image generation system including an image generator for generating a video signal;
a video display, operatively connected to the image generator, for displaying a video image based on the generated video signal; and
a lens positioned between the operator and the video display, wherein the operator perceives through the lens the displayed image as a far-focused virtual image.

2. The visual display system of claim 1, wherein the lens is a positive aspheric lens.

3. The visual display system of claim 2, wherein the positive aspheric lens is a Fresnel type lens.

4. The visual display system of claim 1, wherein the lens is an achromatic lens.

5. The visual display system of claim 4, wherein the achromatic lens is a Fresnel type lens with color separation correction.

6. The visual display system of claim 1, wherein the lens has an associated focal length designed such that the displayed image viewed through the lenses appears at a predetermined distance.

7. The visual display system of claim 1, wherein the lens includes a planar surface.

8. The visual display system of claim 7, wherein the lens is oriented substantially parallel to the video display and substantially perpendicular to a line extending from the operator's viewpoint.

9. The visual display system of claim 1, wherein the lens is one or more optical elements for producing a substantially distortion-free, collimated image

10. The visual display system of claim 1, wherein the video display includes a flat-panel display.

11. A method for producing a display image operator perceived as a far-focused virtual image by an operator, the method comprising:
generating a video signal; and
displaying a video image on a display device based on the generated video signal; and
positioning a lens between the operator and the video display, wherein the operator perceives through the lens the displayed image as a far-focused virtual image.

12. The method of claim 11, wherein the lens has an associated focal length designed such that the displayed image viewed through the lenses appears at a predetermined distance.

13. The method of claim 11, wherein the lens includes a planar surface.

14. The method of claim 13, wherein the lens is oriented parallel to the video display and substantially perpendicular to a line extending from the operator's viewpoint.

15. The method of claim 11, wherein the lens is a positive aspheric lens.

16. The method of claim 15, wherein the positive aspheric lens is a Fresnel type lens.

17. The method of claim 11, wherein the lens is an achromatic lens.

18. The method of claim 17, wherein the achromatic lens is a Fresnel type lens with color separation correction.

19. The method of claim 11, wherein the lens is one or more optical elements for producing a substantially distortion-free, collimated image

20. The method of claim 11, wherein the video display includes a flat-panel display.

21. A visual display system for producing a display image perceived as a far-focused virtual image by an operator, the display system comprising:
a video image generation system including an image generator for generating a video signal;
a video display, operatively connected to the image generator, for displaying a video image based on the generated video signal; and
a lens positioned between the operator and the video display, wherein the lens is an achromatic lens that includes a planar surface, wherein the operator perceives through the lens the displayed image as a far-focused virtual image, and wherein the lens has an associated focal length designed such that the displayed image viewed through the lenses appears at a predetermined distance.

22. The visual display system of claim 21, wherein the lens is oriented parallel to the video display and substantially perpendicular to a line extending from the operator's viewpoint.

23. The visual display system of claim 21, wherein the achromatic lens is a Fresnel type lens with color separation correction.

24. The visual display system of claim 21, wherein the video display includes a flat-panel display.
